(19) United States
(12) Patent Application Publication
(10) Pub. No.: US 2020/0197991 A1
(43) Pub. Date: Jun. 25, 2020

(54) RESOURCE RECOVERY/RECYCLING FACILITY USING SUPERHEATED STEAM

(71) Applicant: Misao KAIZAN, Wakegun Okayama (JP)

(72) Inventor: Misao KAIZAN, Wakegun Okayama (JP)

(21) Appl. No.: 16/629,042

(22) PCT Filed: Jun. 20, 2018
(86) PCT No.: PCT/JP2018/023474

§ 371 Date: Jan. 7, 2020

(30) Foreign Application Priority Data
Jul. 7, 2017 (JP) 2017-144911

(51) Int. Cl. B09B 3/00; C10B 53/07; C10B 27/06; B01D 53/38; B01D 53/76; C10G 1/04

(52) U.S. Cl. CPC B09B 3/0091; C10B 53/07; C10B 27/06; C10G 2300/1003; B01D 53/76; C10G 1/04; B01D 2258/0291; B01D 53/38

(57) ABSTRACT

One of Japan's current environmental problems is the fact that approximately 70% of the world's incinerators for waste disposal are Japanese incinerators. Although problems such as PPM are now being addressed, discharge at the particulate level into the atmosphere still occurs. In addition, harmful substances including residual chlorine remain in residual ash, and there is a limit to the disposal of waste soil by burying. Furthermore, the costs for maintaining the energy required for incineration are enormous. The present invention is capable of solving all of the aforementioned problems, as well as reducing said maintenance costs, and effectively using unwanted substances currently considered waste by recovering, recycling, and regenerating the same.

### TECHNICAL FIELD

Among incinerating incinerators, charcoal fired furnaces, electric melting furnaces, fuel melting furnaces, etc., incinerators are the primary offenders when it comes to air pollution and soil pollution.

### BACKGROUND OF THE INVENTION

One of Japan's current environmental problems is the fact that approximately 70% of the world's incinerators for waste disposal are Japanese incinerators. Although problems such as PPM are now being addressed, discharge at the particulate level into the atmosphere still occurs, causing air pollution. In addition, harmful substances including residual chlorine remain in residual ash, with the disposal of waste soil by burying leading to soil pollution and resultant water quality pollution, thereby limiting what can be buried. Furthermore, the costs for maintaining the energy required for incineration are enormous. The present invention is capable of solving all of the aforementioned problems, with the proposed object of reducing said maintenance costs, and effectively using unwanted substances currently considered waste by recovering, recycling, and regenerating the same.

### PRIOR ART DOCUMENTS

Patent Document
Patent Document 1: JP 2007-54815 A

### SUMMARY OF THE INVENTION

### Problems to be Solved by the Invention

The object is safe regeneration recycling which can eliminate air pollution, reduce incineration energy maintenance costs required for conventional incinerators, change the point of view that waste is an unwanted substance, and utilize waste as a resource to generate profits.

Grouping current intermediate disposal plants and final disposal plants into a single group, costs such as excess facility investment (approximately one hundred million per 1 t) and labor costs can be reduced.

### Means for Solving the Problems

In order to lead to a decomposition route, a separation route, and a regeneration route, the theme is based on a facility which introduces or revises the current new techniques and includes the machinery necessary to regenerate resources that can be optimized. Moreover, by advocating safety and reduced maintenance costs here, this is proposed as a facility which prevents environmental disruption on a global scale and is therefore greatly desired by the world.

### Effects of the Invention

By changing the point of view that waste is an unwanted substance, waste can be utilized as a resource in a non-oxygen state which uses water energy and does not catch fire so as to generate profits. By grouping the decomposition route, the separation route, and the regeneration route as a resource recovery/recycling facility, in addition to grouping the current intermediate disposal plant and final disposal plant into a single group, costs such as excess facility investment (approximately one hundred million per 1 t) and labor costs can be reduced.

### BRIEF DESCRIPTION OF THE DRAWINGS

FIG. 1 is a flowchart of a resource recovery/recycling facility according to the present invention.

FIG. 2 is a flowchart of the decomposition route/separation route/regeneration route.

FIG. 3 is an overall view of a heat-resistant container.

FIG. 4 is an overall view illustrating the state in which the switching hatch is opened.

FIG. 5 is a cross-sectional view of the container.

FIG. 6 is an attachment view of a steam injection pipe to a container injection hole.

### EMBODIMENT OF THE INVENTION

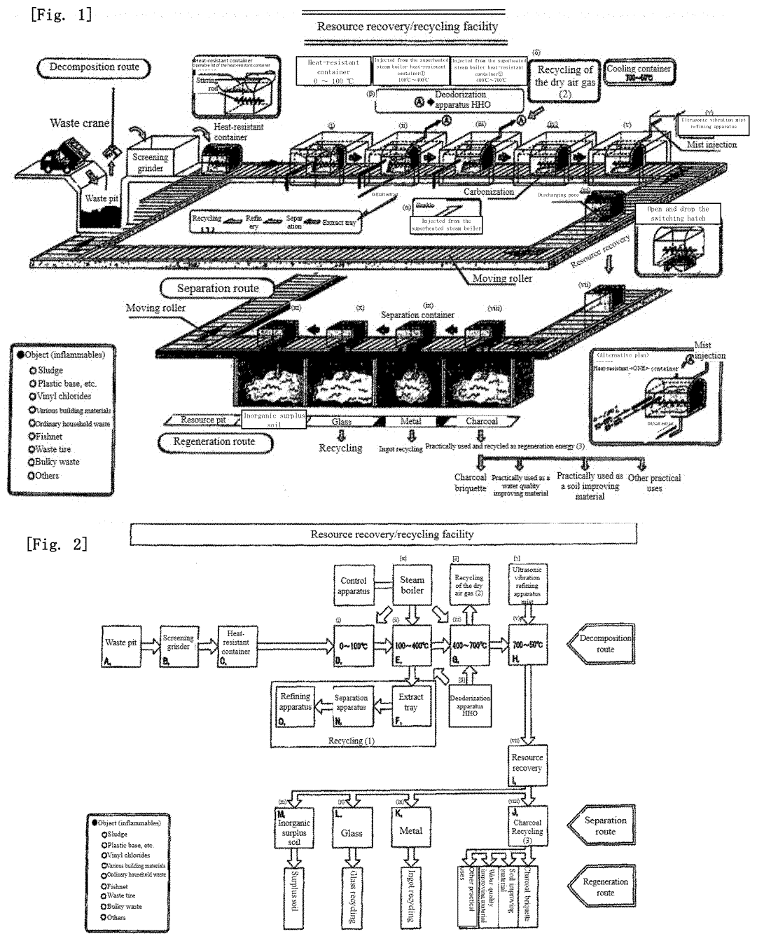

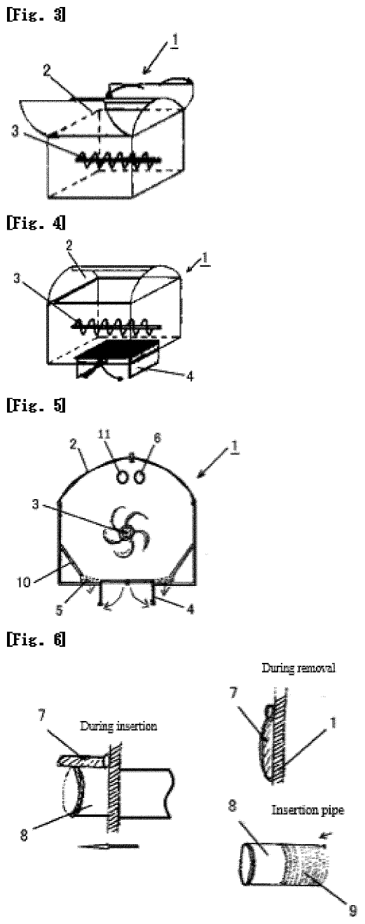

The flow of the decomposition route diagram illustrated in FIGS. 1 and 2 will be described.

A. Resource waste collected in a waste pit.

B. The resource waste is moved to a container 1 in the decomposition route on the second floor using a crane.

Note: The storage amount of the resource waste forms the size of the container 1 in accordance with the required amount.

* Regarding a high water content
1. Using a high speed flowing drying apparatus, the water content of waste is set to 10 to 15%.
2. Waste having a water content of 10 to 15% is placed in a heat-resistant container.

C. The door of an openable lid 2 of the heat-resistant container is closed.

D. A built-in stirring rod 3 is rotated.

E. First, as illustrated in (i), water molecules inside the container are increased to a boiling point of 100° C. using the steam from a boiler.

F. Subsequently, as illustrated in (ii), the steam is further heated to 100° C. to 400° C. to increase the temperature inside the container.
※ The dioxin generation temperature is approximately 250° C. to 400° C. (toxic gas is generated for approximately 30 minutes to produce a large amount of gas.

G. Using the pipe illustrated in (A), HHO gas is injected to reform the toxic gas.

H. If a liquefaction system is applied for regeneration, an extract (emulsified mixture of water/oil/salt) obtained at the heating stage is separated, refined, and recycled.

I. The heated steam of D is further heated to 400° C. to 700° C., and applied to a carbonization system, thereby increasing the temperature inside the container.

J. Using raw dregs, etc., the temperature inside the container is decreased from 700° C. to 50° C.

K. A discharging hatch 4 at the bottom of the container is opened to move the resources of the obtained recovery waste to a separation route on the first floor.

A pipe 9 of a new surface heater (multiple steel materials are mixed to make the material into a thin shape) is used in order to heat at (ii) 100° C. to 400° C. and (iii) 400° C. to 700° C. in an injection port of an injection pipe 8 for forming superheated steam from a steam boiler (100° C.) of (α).

A new surface heater pipe 9 is adopted in the injection pipe 8 employing a refractory material for a steam generation apparatus in order to set the temperature to the target temperature. When the temperature of the container is 0 to 100° C., 100° C. to 400° C., or 400° C. to 700° C., and a heat source is wound around the pipe itself, the object is achieved by passing through the piping thereof.

A deodorization apparatus of (β) uses the HHO gas.

Vaporized gas generated at the heating stage is toxic. A facility utilizing the HHO gas is obtained to promote the neutralization of the toxic gas. The steam is electrolyzed to create the HHO gas. The HHO gas burns to produce water.

Vibrations using cooling apparatus facility ultrasonic waves via ultrasonic mist of (γ) can produce water in mist form, thereby rapidly cooling water.

When the temperature inside the container reaches 700° C., water becomes mist using the ultrasonic vibrations of K. The injection allows the temperature inside the container to decrease to 200° to 50° C.

Separation route (first floor) (oil, vaporized gas, water, charcoal)

1. The extract of a decomposition route F (oil and water) is separated into water and oil based on the specific gravity thereof.

2. The energy of dry air gas generated in (δ) is obtained. This is moved to regeneration.
Note: At the heating stage, the toxic gas generated at (100° C. to 400° C.) is neutralized to be safer by employing the HHO gas.

3. (L) The container discharging hatch 4 is opened to move the resources therein to the lower stage container, wherein charcoal obtained in this decomposition passes through a grinder and a sieve so as to be regenerated into various objects as powder in a regeneration route.

4. Regeneration route (first floor)

(Oil)

A mixture of oil and water obtained in a decomposition route E is separated and regenerated.

Oil can be refined into light oil, gasoline, or heavy oil in order to achieve self recycling, or combined with an electric generator to sell power to a utility.

(Vaporized Gas)

When carbonization starts at 200° C. to 400° C. in the decomposition route, gas is generated.

The obtained gas of δ is regenerated as a heat source.
A large amount of the gas is mainly generated at 200 to 400° C. In order to be able to utilize the dry air gas energy for private power generation or move the electric generator to sell power to a utility, a technique which allows gas to be uniformly emitted must be utilized.
Note: At the heating stage, because the gas generated at (200° C. to 400° C.) is toxic, the HHO gas is utilized or a catalyst is used to promote safer neutralization.

(Charcoal)

1, For example, a “charcoal briquette” consisting of common charcoal is mainly used at 300° C. to 400° C., while the temperature of the charcoal fire this time is 600° C. to 700° C., making it a charcoal briquette which has energy identical to that of coconut activated charcoal, in addition to exerting the effects of far infrared rays and good stability.

2, For example, a “soil improving agent” exerts action such that when it is mixed with wood flours, .grains, composts, etc., and .sowed in fields, forcing harmful materials (agricultural chemicals, chemical fertilizers, etc.) to be adsorbed into the pores of the charcoal and neutralize the toxicity thereof. Moreover, far infrared rays called growing light are also generated and therefore contribute to the growth of crops.

3, For example, as a “water improving agent,” the oxidation and pollution of water is improved. It has minus ions along with reduction action, allowing it to be utilized to improve sludge. Sound sleep effects, etc.

4. For example, as “nightwear and bedding,” the action for reducing moisture (blood, etc.) in the body and increasing the temperature in the body, etc.

5, For example, the effects (in which the utilization in “building materials, floors of houses, and damp places” makes it difficult to repel moisture and harmful insects), etc.

6. Deodorization and drying purposes, in order to improve sense of taste

7. Other practical uses

The flow and description of the diagram of the regeneration route (B)

Resources introduced by the decomposition route

1. Water, oil, and a mixed emulsion which are produced in (ii) are separated by the specific gravity thereof, then refined, and utilized in our company-owned facility, etc.

2. Residues such as chlorine, arsenic, and nitrogen are recycled as dry air gas or diluted by steam, but also further neutralized using the HHO gas or detoxified employing a catalyst, then used as the operation energy of an electric generator. Residual water is transferred to safely use and flow a purification layer.

3. Application and practical uses are anticipated for the regeneration recycle of charcoal 1 to 7 of (J).

4. The regeneration recycle is anticipated for ingots of each kind of metal of (K).

5. Can be practically used as the regeneration recycle of glass of (L).

6. Residual ash, surplus soil, etc. are heated at 600 to 700° C. for 30 minutes, and therefore do not deteriorate the environment of fungi, etc. and are subjected to residual harmful materials treatment, such that those which provide security and safety and do not cause environmental deterioration (that has no disposal spot due to residual ash of an incineration part, etc.) can be used. This can be recycled into recycled bricks, blocks, etc.

A roller or rail is used to move containers. A two stage structure roller (capable of changing directions at corners) or a rotating plate (capable of switching directions) is installed so as to form a system in which vertical switching enables horizontal switching.

However, this facility cannot respond to other harmful materials such as asbestos, PCBs, and radioactivity.

### EXPLANATION OF THE SYMBOLS

1 Heat-resistant container
2 Openable lid of the heat-resistant container
3 Stirring rod
4 Discharging hatch
5 Extract tray
6 Steam injection hole
7 Switching valve
8 Injection pipe and exhaust pipe
9 New surface heater coil
10 Inclined part
11 Reflux gas discharge port

1. A superheated steam resource recovery/recycling facility for recycling resource waste in decomposition/separation/regeneration routes, the facility comprising: a decomposition route, wherein the resource waste is housed in a heat-resistant container, an injection pipe is inserted into a steam injection port provided in the container (while a stirring rod built in the container is rotated), the temperature therein is increased to a boiling point of 100° C. using steam, heating is further carried out to 100° C. to 400° C. using a second injection pipe to increase the temperature inside the container, the steam of vaporized gas and an extract (emulsified mixture of water/oil) which is generated at the heating stage is removed from an exhaust pipe and further heated to 400° C. to 700° C. to increase the temperature inside the container, after which ultrasonic vibration mist is injected to decrease the temperature inside the container to 50° C.; a separation route, wherein a discharging hatch at the bottom of the container is opened to move the resources of recovery waste to a separation route container; and a regeneration route for recycling the resources.

2. The superheated steam resource recovery/recycling facility according to claim 1, wherein a switching hatch is provided such that the stirring rod is provided inside the heat-resistant container with the lower surface of the container having an inclined part, a wire net shaped tray for gathering a mixture of oil and water is provided on both sides of the discharging hatch, and a pipe injection port is further provided in order to detoxify harmful gas generated by heating and generate superheated steam gas for increasing the temperature inside the container.

3. The superheated steam resource recovery/recycling facility according to claim 1, wherein a steam injection hole having a switching valve is provided at the top of the heat-resistant container.

4. The superheated steam resource recovery/recycling facility according to claim 1, wherein a new surface heater coil with an aluminum plate (approximately 0.2 mm) subjected to special coating is used for a heat-resistant pipe of 0° C. to 100° C., 100° C. to 400° C., 400° C. to 700° C. in order to raise the temperature of the container.
